(19) United States
(12) Patent Application Publication
(10) Pub. No.: US 2023/0096773 A1
(43) Pub. Date: Mar. 30, 2023

(54) MITIGATING FIRE RISKS IN VEHICLES

(71) Applicant: Motional AD LLC, Boston, MA (US)

(72) Inventors: Linh Hong Pham, Cambridge, MA (US); Christopher Konopka, Peabody, MA (US)

(21) Appl. No.: 17/952,597

(22) Filed: Sep. 26, 2022

Related U.S. Application Data
(60) Provisional application No. 63/249,268, filed on Sep. 28, 2021.

(51) Int. Cl. B60Q 9/00; G08B 17/06; G08B 21/02; G08B 25/10; F02D 41/02; B60Q 5/00

(52) U.S. Cl. CPC B60Q 9/00; G08B 17/06; G08B 21/02; G08B 25/10; F02D 41/021; B60Q 5/005; F02D 2200/70

(57) ABSTRACT

Among other things, techniques are described for preventing and mitigating fire risks on a vehicle. For example, multiple sensor inputs are provided to a predictive model which determines fire scenarios. A first fire risk data and second fire risk data are received from the sensors, and data indicative of fire prevention and fire mitigation is received. At least one fire prevention measure applicable to the first imminent fire risk condition and the second imminent fire risk condition is determined. The first fire risk data and the second fire risk data are compared to the fire mitigation thresholds. At least one fire mitigation measure applicable to the first imminent fire risk condition and the second imminent fire risk condition is determined. The at least one fire prevention measure or the at least one fire mitigation measure is activated.

### CROSS REFERENCE TO RELATED APPLICATIONS

The present application claims priority to U.S. Provisional Patent Application No. 63/249,268, filed on Sep. 28, 2021, the entire contents of which are incorporated herein by reference.

### FIELD OF THE INVENTION

This description relates to mitigating fire risks in vehicles.

### BACKGROUND

Vehicles can experience a fire caused by, e.g., mechanical or electrical factors, external events, etc. Further, if a vehicle is an autonomous vehicle, a human operator may not be available to respond to a fire or to events preceding a fire. Even if an autonomous vehicle is carrying a human passenger, the passenger is not necessarily monitoring operations of the vehicle and may not be sufficiently aware of an imminent fire risk in order to respond.

### BRIEF DESCRIPTION OF THE DRAWINGS

FIG. 1 shows an example of an autonomous vehicle (AV) having autonomous capability.

FIG. 2 shows an example “cloud” computing environment.

FIG. 3 shows an example computer system.

FIG. 4 shows an example architecture for an AV.

FIG. 5 shows a flowchart of an example process for detecting, preventing and/or mitigating fire on a vehicle.

FIG. 6 shows an example block diagram of a vehicle with fire prevention and fire mitigation systems.

FIG. 7 shows a representation of an example predictive model used in fire prevention and fire mitigation.

FIG. 8 shows an implementation of example fire prevention and fire mitigation systems.

FIG. 9 shows an implementation of an example sensor array used in fire detection.

FIG. 10 shows an implementation of example fire mitigation systems.

FIG. 11 shows a flowchart representing an example process for starting fire prevention measures and/or fire mitigation measures on a vehicle.

### DETAILED DESCRIPTION

In the following description, for the purposes of explanation, numerous specific details are set forth in order to provide a thorough understanding of the present disclosure. It will be apparent, however, that the present disclosure can be practiced without these specific details. In other instances, well-known structures and devices are shown in block diagram form in order to avoid unnecessarily obscuring the present disclosure.

In the drawings, specific arrangements or orderings of schematic elements, such as those representing devices, modules, systems, instruction blocks, and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Some embodiments of the present disclosure are described herein in connection with a threshold. As described herein, meeting a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. Autonomous Vehicle Architecture

4. Preventing and Mitigating Fire Risks in Vehicles

### General Overview

A vehicle (such as an autonomous vehicle) can use multiple types of sensors to mitigate the risk of an imminent internal fire. As used herein, an imminent internal fire refers to a situation in which a fire is likely due to conditions within the vehicle. For example, the sensors together can monitor various characteristics that could indicate an imminent fire. Further, if a fire risk is detected, preventive measures are activated, and mitigation measures can be used in the event of an active fire (i.e., a fire that has already begun).

Some of the advantages of these techniques include: reducing the risk of fire by preemptively identifying where the fire is likely to start in the vehicle, limiting the effect of the internal fire on passengers and vehicles associated with the vehicle by mitigating or extinguishing the fire, alerting passengers and nearby individuals to avoid the fire risk, and reducing the occurrence of false alarms by the use of multiple types of sensors. Systems (e.g., AV systems) more accurately determine whether the risk of a fire is increasing and, as a result, will adjust operation of the systems to mitigate or eliminate the risk of the fire.

### System Overview

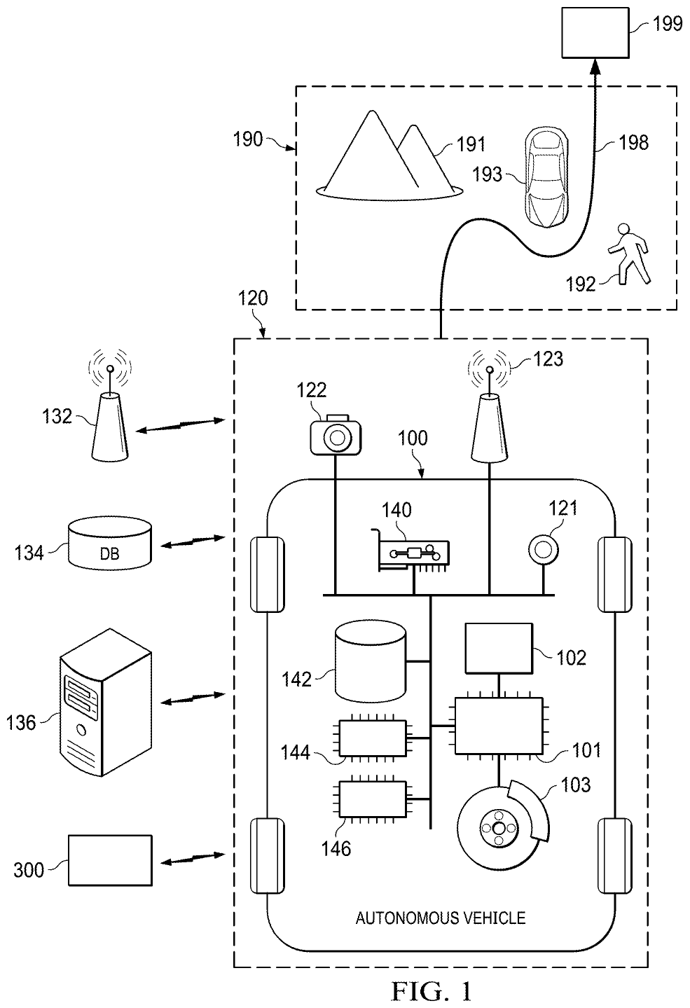

FIG. 1 shows an example of an AV 100 having autonomous capability.

As used herein, the term “autonomous capability” refers to a function, feature, or facility that enables a vehicle to be partially or fully operated without real-time human intervention, including without limitation fully AVs, highly AVs, and conditionally AVs.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

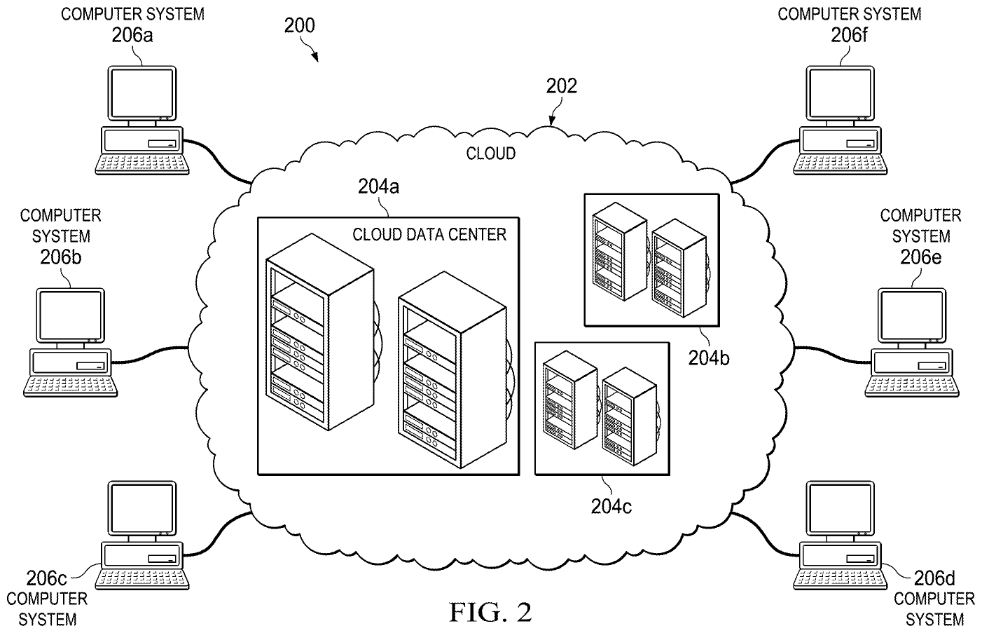

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 200 described below in accordance with FIG. 2.

In general, this document describes technologies applicable to any vehicles that have one or more autonomous capabilities including fully AVs, highly AVs, and conditionally AVs, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially AVs and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems can automate certain vehicle operations (e.g., steering, braking, and using maps) under certain operating conditions based on processing of sensor inputs. The technologies described in this document can benefit vehicles in any levels, ranging from fully AVs to human-operated vehicles.

AVs have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the vehicle 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

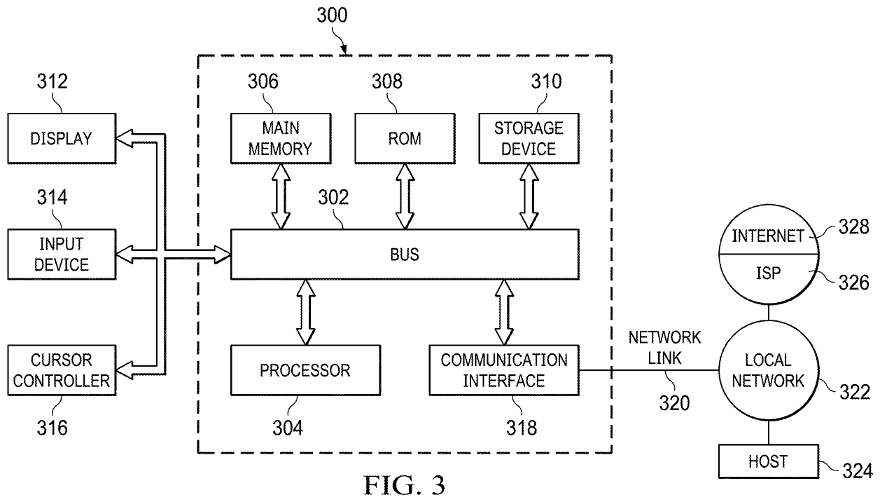

In an embodiment, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, include instructions for a vehicle to start moving forward, stop moving forward, start moving backward, stop moving backward, accelerate, decelerate, perform a left turn, and perform a right turn. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the vehicle 100, such as the AV's position, linear and angular velocity and acceleration, and heading (e.g., an orientation of the leading end of vehicle 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the vehicle 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the vehicle 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) and Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among AVs.

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication devices 140 transmit data collected from sensors 121 or other data related to the operation of vehicle 100 to the remotely located database 134. In an embodiment, communication devices 140 transmit information that relates to teleoperations to the vehicle 100. In some embodiments, the vehicle 100 communicates with other remote (e.g., “cloud”) servers 136.

In an embodiment, the remotely located database 134 also stores and transmits digital data (e.g., storing data such as road and street locations). Such data is stored on the memory 144 on the vehicle 100, or transmitted to the vehicle 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data can be stored on the memory 144 on the vehicle 100, or transmitted to the vehicle 100 via a communications channel from the remotely located database 134.

Computer processors 146 located on the vehicle 100 algorithmically generate control actions based on both real-time sensor data and prior information, allowing the AV system 120 to execute its autonomous driving capabilities.

In an embodiment, the AV system 120 includes computer peripherals 132 coupled to computer processors 146 for providing information and alerts to, and receiving input from, a user (e.g., an occupant or a remote user) of the vehicle 100. In an embodiment, peripherals 132 are similar to the display 312, input device 314, and cursor controller 316 discussed below in reference to FIG. 3. The coupling is wireless or wired. Any two or more of the interface devices can be integrated into a single device.

In an embodiment, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In an embodiment, the privacy level specifies particular information associated with a passenger that is deleted once the ride is completed. In an embodiment, the privacy level specifies particular information associated with a passenger and identifies one or more entities that are authorized to access the information. Examples of specified entities that are authorized to access information can include other AVs, third party AV systems, or any entity that could potentially access the information.

A privacy level of a passenger can be specified at one or more levels of granularity. In an embodiment, a privacy level identifies specific information to be stored or shared. In an embodiment, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In an embodiment, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 shows an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, AVs (including, cars, drones, shuttles, trains, buses, etc.) and consumer electronics. In an embodiment, the computing systems 206a-f are implemented in or as a part of other systems.

FIG. 3 shows a computer system 300. In an embodiment, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or can include one or more general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a processor 304 coupled with a bus 302 for processing information. The processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 can optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above in accordance with FIG. 2.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### AV Architecture

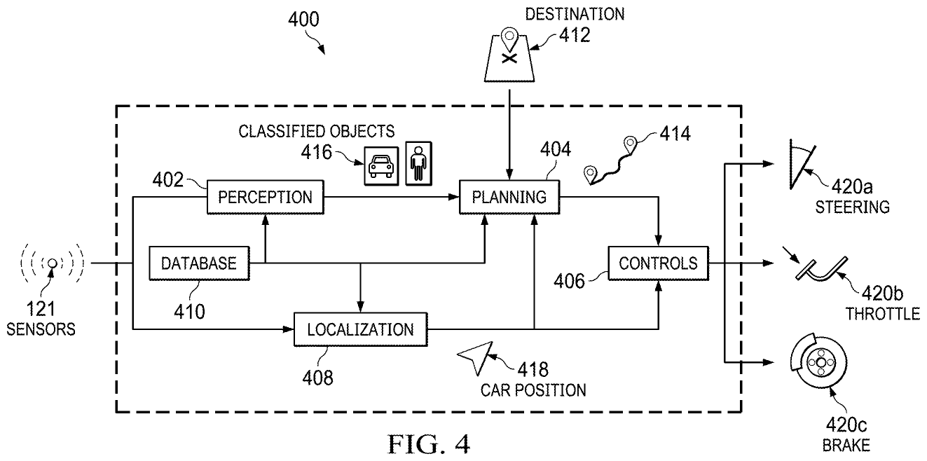

FIG. 4 shows an example architecture 400 for an AV (e.g., the vehicle 100 shown in FIG. 1). The architecture 400 includes a perception system 402 (sometimes referred to as a perception circuit), a planning system 404 (sometimes referred to as a planning circuit), a control system 406 (sometimes referred to as a control circuit), a localization system 408 (sometimes referred to as a localization circuit), and a database system 410 (sometimes referred to as a database circuit). Each system plays a role in the operation of the vehicle 100. Together, the systems 402, 404, 406, 408, and 410 can be part of the AV system 120 shown in FIG. 1. In some embodiments, any of the systems 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the systems 402, 404, 406, 408, and 410 is sometimes referred to as a processing circuit (e.g., computer hardware, computer software, or a combination of the two). A combination of any or all of the systems 402, 404, 406, 408, and 410 is also an example of a processing circuit.

In use, the planning system 404 receives data representing a destination 412 and determines data representing a trajectory 414 (sometimes referred to as a route) that can be traveled by the vehicle 100 to reach (e.g., arrive at) the destination 412. In order for the planning system 404 to determine the data representing the trajectory 414, the planning system 404 receives data from the perception system 402, the localization system 408, and the database system 410.

The perception system 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning system 404.

The planning system 404 also receives data representing the AV position 418 from the localization system 408. The localization system 408 determines the AV position by using data from the sensors 121 and data from the database system 410 (e.g., a geographic data) to calculate a position. For example, the localization system 408 uses data from a GNSS (Global Navigation Satellite System) sensor and geographic data to calculate a longitude and latitude of the AV. In an embodiment, data used by the localization system 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control system 406 receives the data representing the trajectory 414 and the data representing the AV position 418 and operates the control functions 420a-c (e.g., steering, throttling, braking, ignition) of the AV in a manner that will cause the vehicle 100 to travel the trajectory 414 to the destination 412. For example, if the trajectory 414 includes a left turn, the control system 406 will operate the control functions 420a-c in a manner such that the steering angle of the steering function will cause the vehicle 100 to turn left and the throttling and braking will cause the vehicle 100 to pause and wait for passing pedestrians or vehicles before the turn is made.

### Preventing and Mitigating Fire Risks in Vehicles

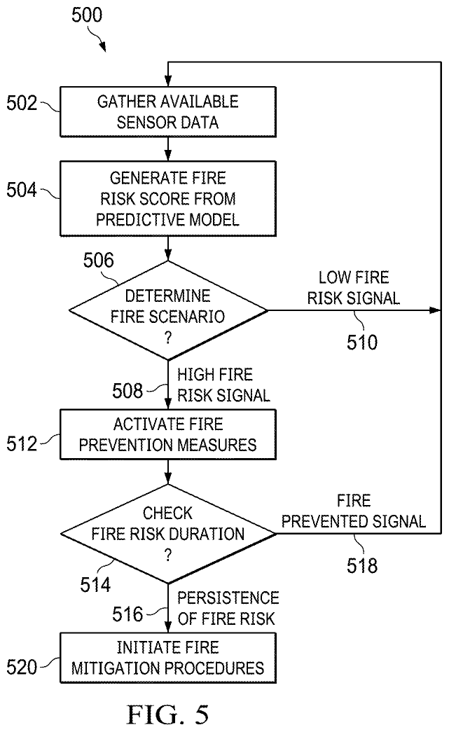

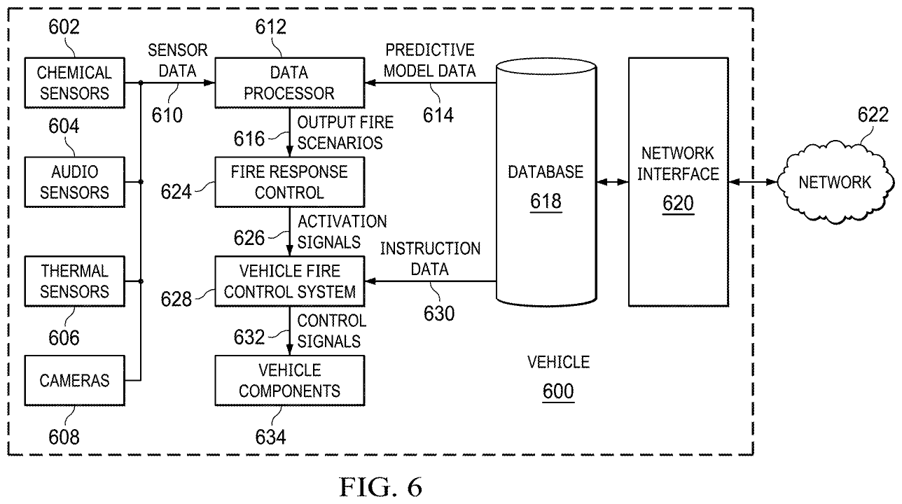

FIG. 5 shows a flowchart of a process 500 for detecting, preventing, and/or mitigating fire in a vehicle. In an embodiment, the process 500 is performed by the processor 304 as shown in FIG. 3. While operations of the method are described below as being performed by specific components, modules, or systems described in FIGS. 6, 7 and 8, it will be appreciated that these operations need not necessarily be performed by the specific components identified, and could be performed by a variety of components and modules, potentially distributed over a number of machines. Accordingly, references may be made to elements of autonomous vehicle 100 or computer system 300 for the purpose of illustrating suitable components or elements for performing a step or sub step being described. Alternatively, at least certain ones of the variety of components and modules described in autonomous vehicle 100 or computer system 300 can be arranged within a single hardware, software, or firmware component. It will also be appreciated that some of the steps of this method may be performed in parallel or in a different order than illustrated.

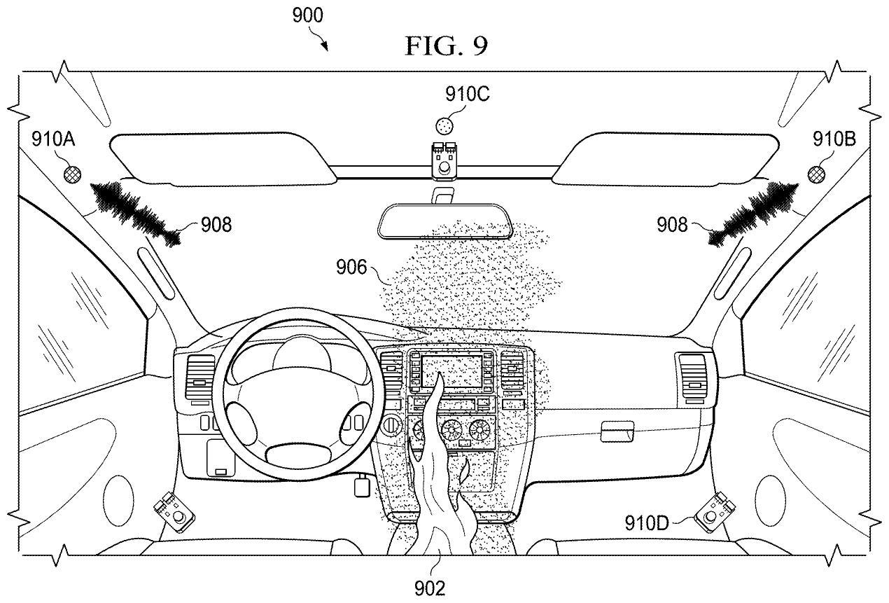

In some embodiments, sensor data from multiple sensors is gathered (block 502). In an embodiment, the sensor data includes camera data associated with at least one image, thermal sensor data associated with at least one temperature reading, audio sensor data associated with sounds occurring inside and/or outside of the cabin of a vehicle (e.g., a vehicle including an AV system such as AV system 120) and chemical sensor data associated with concentration reading of at least one chemical substance (e.g. carbon monoxide), although it will be understood that other embodiments can include more, less, or different sensor data. An example implementation of a sensor array 910 is described below in accordance with FIG. 9. In an embodiment, the data is processed into respective canonical forms as inputs to subsequent systems. Canonical forms are standardized forms into which the output data from various sensors of the same category are modified, given that the various sensors of the same category may output data of different formats. For example, output images of various models of cameras are standardized to be 8-bit RGB images and output readings of various thermal sensors are standardized to be temperature readings in Kelvin (K). The example canonical forms mentioned above are not limiting for the outputs and other canonical forms exist for each type or each category of the sensors. In an embodiment, each type of sensor data can indicate whether at least one fire risk condition is or is not present. For example, a high thermal sensor reading near the engine of the vehicle indicates an overheated engine whereas a low thermal sensor reading indicates that the engine is operating at an appropriate temperature. As another example, a high chemical sensor reading in the hood of the vehicle indicates a potential fuel leakage whereas a low chemical sensor reading indicates that a fuel leakage is not present. The sensor data is further described below in accordance with

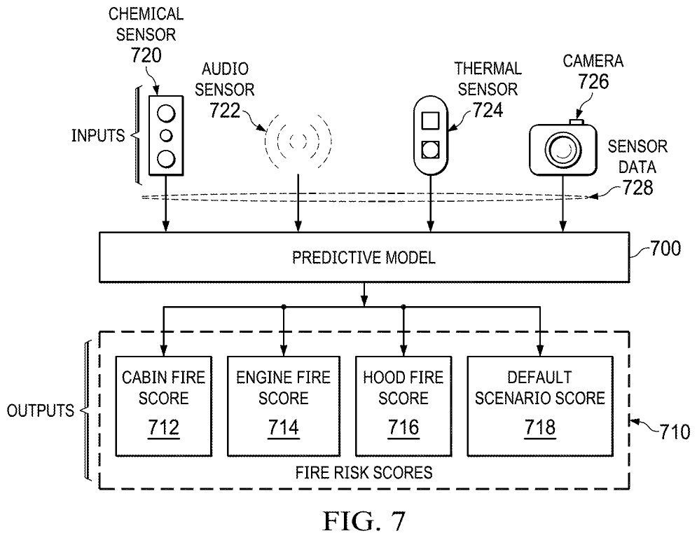

Fire risk data is generated (block 504) based on the sensor data by a predictive model. Fire risk data represents a likelihood that each of a set of pre-determined fire scenarios will occur. The predictive model takes as inputs the gathered (block 502) sensor data and outputs fire risk data which corresponds to one or more pre-determined fire scenarios. Details regarding fire risk data, the predictive model and the fire scenarios are described below in accordance with FIGS. 6 and 7.

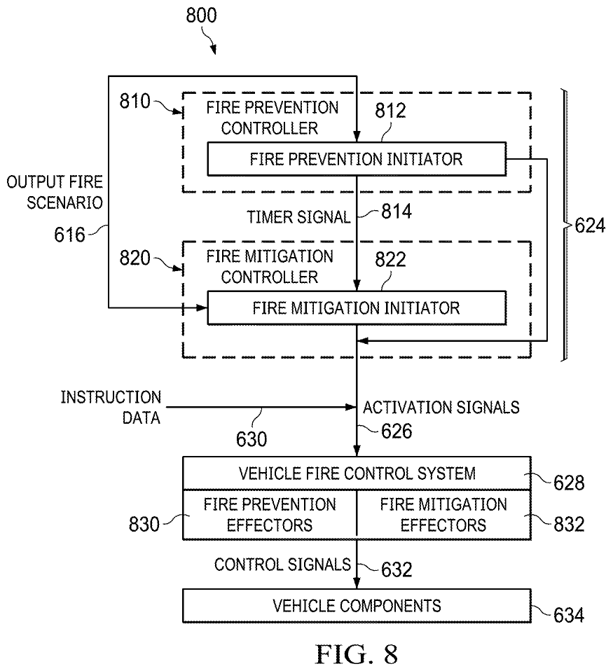

After the fire risk data is generated, a fire risk is determined (block 506) based on at least one pre-determined rule. Details regarding the determining and the at least one pre-determined rule are described below in accordance with FIG. 7. If a fire is likely to start or likely to already have started (e.g., when the fire risk data, which represents a likelihood of a fire scenario, meets a threshold likelihood), the predictive model identifies an imminent fire risk while a high fire risk signal 508 is generated. If a fire is unlikely to start (e.g., when the fire risk data, which represents a likelihood of a fire scenario, does not meet a threshold likelihood), a low fire risk signal 510 is generated. In the event of a low fire risk signal 510, the system continues to gather (block 502) sensor data. Further, when a fire is mitigated, the fire risk returns to a low level, and a low fire risk signal 510 is also generated. Details regarding high and low fire risk signals are described below in accordance with FIG. 8.

A vehicle fire control system takes as inputs fire risk signals and instructs relevant systems based on the type of fire risk signal received. In an embodiment, the vehicle fire control system is part of (e.g., is implemented using) the processor 304 shown in FIG, 3. If a high fire risk signal 508 is received by the vehicle fire control system, the vehicle fire control system instructs relevant systems, such as an engine control of a fire prevention controller, to prevent (block 512) the fire from starting. An example implementation of the vehicle fire control system 628 is described in accordance with FIGS. 6 and 8. The vehicle fire control system sends appropriate activation signals to relevant systems based on the determined fire scenario and parts of the vehicle affected. The relevant systems receiving the instructions to prevent the fire will lower the fire risk. Details regarding the vehicle fire control system and the relevant systems can be found below in accordance with FIGS. 6 and 8.

When a high fire risk signal 508 is first generated, the duration of the high fire risk is checked (block 514). If the fire persists, the high fire risk signal 508 will remain, and the duration of the high fire risk signal 508 is updated. Once the duration meets a pre-defined threshold time, the fire is determined to not be prevented (block 512) by the prevention measures, and a persistence of fire risk signal 516 is generated. The persistence of fire risk signal 516 indicates the necessity of fire mitigation procedures. In this case, a set of control signals will be sent by the vehicle fire control system to relevant systems, such as a coolant compartment controller of a fire mitigation controller, to initiate (block 520) fire mitigation procedures.

By contrast, if the fire is prevented (block 512) by the fire prevention measures, the fire risk changes from high to low. As the imminent fire is prevented (block 512), the duration checked (block 514) does not meet the threshold time and is reset, and a fire prevented signal 518 is generated, instructing the system to continue to gather (block 502) input data from the sensors. Details regarding the fire prevention procedures and fire mitigation procedures can be found below in accordance with FIG. 8.

FIG. 6 shows a block diagram of a vehicle 600 which includes example implementation of the vehicle fire control system described in FIG. 5. In an embodiment, the vehicle 600 is an implementation of the autonomous vehicle 100. The vehicle system 600 includes mounted sensors. In an embodiment, the vehicle 600 includes chemical sensors 602, audio sensors 604, thermal sensors 606 and cameras 608, although in other embodiments the vehicle 600 can include more, fewer, or different sensors. An sensor array can include, for example, chemical sensors 602, audio sensors 604, thermal sensors 606 and cameras 608. An exemplary sensor array 910 is described in accordance with FIG. 9. In an embodiment, the sensors are mounted in the interior of the vehicle 600, such as within a passenger compartment, an engine compartment, or some other interior portion of the vehicle 600. The various mounted sensors output sensor data 610, which is received by a data processor 612. In an embodiment, the sensors are capable of outputting sensor data 610 in canonical forms. In an embodiment, the data processor 612 is capable of converting the sensor data 610 into canonical forms.

The data processor 612 also receives predictive model data 614 from a database 618. In an embodiment, the database 618 is part of the database system 410 shown in FIG. 4. A predictive model is a classifier trained to detect possible fire scenarios. Details regarding the predictive model can be found below in accordance with FIG. 7. In an embodiment, the data processor 612 is at least partially an on-board processing circuit local to the vehicle, such as part of the processor 304 shown in FIG. 3. In an embodiment, the data processor 612 is at least partially a remote processing circuit, such as part of the cloud 202 shown in FIG. 2. In an embodiment, the database 618 is connected with a network interface 620, which allows data transfer from the database 618 to a remote storage medium through a network 622. In an embodiment, the remote storage medium is a computer system accessible through a cloud 202 shown in FIG. 2. In an embodiment, the network interface 620 is a part of the communication interface 318 in FIG. 3. The network 622 is either a local network or the Internet.

The data processor 612 constructs (e.g., constructs and prepares for training) a predictive model based on the predictive model data 614. In an embodiment, the predictive model data 614 is a compressed form of the predictive model that includes information about both the architecture of the predictive model and the weights and/or rules used in the predictive model. The data processor 612 then provides the sensor data 610 to the predictive model. The predictive model generates fire risk data and then determines and outputs fire scenarios 616. Details regarding how the output fire scenarios 616 are determined based on the fire risk data can be found below in accordance with FIG. 7.

Once the output fire scenarios 616 are determined, a fire response control system 624 determines, based on the output fire scenarios 616 received, an appropriate response. In an embodiment, if a fire scenario is determined where a fire is likely to start, the fire response control system 624 will generate activation signals 626 to a vehicle fire control system 628. If a scenario indicative of no or low fire risk is determined, the fire response control 624 commands, via an activation signal 626, the vehicle fire control system 628 to wait for further output fire scenarios. In such an embodiment, the activation signal 626 corresponding to a scenario indicative of no or low fire risk is a null signal, which commands the vehicle fire control system 628 to continue waiting for further inputs. Details regarding the fire response control 624 system can be found below in accordance with FIG. 8.

The vehicle fire control system 628 receives activation signals 626 from the fire response control 624 and requests instruction data 630 from the database 618. In an embodiment, the vehicle fire control system 628 is part of the processor 304 shown in FIG. 3. The instruction data 630 can be stored locally in the database 618 or requested on demand from a remote storage medium accessible through the network 622. The instruction data 630 includes information about a queue or a set of instructions directed to subsequent systems. The queue of instructions ensures the most effective measure to counter a fire scenario is performed first. After receiving the activation signals 626 and loading the instruction data 630, the vehicle fire control system 628 generates control signals 632 to vehicle components 634. Details regarding the control signals 632 can be found below in accordance with FIG. 8.

FIG. 7 shows a block diagram of how the predictive model 700 determines the output fire scenarios 616. In an embodiment, the predictive model 700 is trained using historical data indicative of fire risk conditions of other vehicles. The historical data includes historical sensor data (e.g., a temperature reading) or other data reflective of at least one fire risk condition (e.g., data associated with an over-heated engine). With a multitude of various types of sensors, such data is abundant. Thus, big data onboard diagnosis (OBD) can aid in the process of constructing the predictive model 700. Big data onboard diagnosis (OBD) utilizes a large amount of input data, including historical sensor data, to build models to analyze and monitor the current condition of an operating vehicle. In an embodiment, one of the models built is the predictive model 700. In an embodiment, the predictive model 700 is a neural network. In an embodiment, the predictive model 700 is a rule-based decision tree. In an embodiment, the predictive model 700 is a neural network augmented by a decision tree. In an embodiment, the predictive model 700 is a gradient boosted tree. In other embodiments, the predictive model 700 is based on some other type of algorithm or model, which can include or be based on some form of machine-learning.

The predictive model 700 takes as inputs sensor data 728. In an embodiment, the sensor data 728 is the sensor data 610 in canonical forms, generated from input data captured by one or more sensors. The one or more sensors may be configured in a sensor array. In the example of FIG. 7, the sensor array includes chemical sensors 720, audio sensors 722, thermal sensors 724 and/or cameras 726. In an embodiment, similar sensor arrays including the sensors 720, 722, 724 and 726 are mounted on vehicles of similar type to the vehicle 600. In an embodiment, during training, the sensor data 728 is recorded before the predictive model 700 is constructed. During training, given the recorded sensor data 728, the predictive model 700 outputs a matching output fire scenario 616. For instance, given a set of sensor data collected when a vehicle operates normally, the predictive model 700 determines an output fire scenario 616 indicating there is no fire.

In an embodiment, the predictive model 700 takes the form of a neural network. In an embodiment, the predictive model 700 generates fire risk data in the form of a set of fire risk scores 710, such that each element of the fire risk scores 710 denotes a likelihood score associated with an output fire scenario 616. In an embodiment, a set of fire risk scores 710 includes a cabin fire score 712, an engine fire score 714, a hood fire score 716 and a default scenario score 718. For instance, the cabin fire score 712 indicates a likelihood of a fire starting in the cabin. Similarly, the engine fire score 714 indicates a likelihood of a fire starting near the engine. The hood fire score 716 indicates a likelihood of a fire starting in the hood. The default scenario score 718 indicates the likelihood of no or low fire risk and the conditions in which the vehicle operates normally. Once the set of fire risk scores 710 is obtained, the most likely fire scenario is determined. The fire scenario with the maximum likelihood score is selected by the predictive model 700 to be an output fire scenario. In embodiments, the output fire scenario is the output fire scenario 616 as described with respect to FIG. 6. The threshold likelihood used to select the output fire scenario is dynamic as the threshold likelihood is an iteratively updated maximum likelihood score in the set of fire risk scores 710, and the maximum likelihood score changes when the predictive model 700 evaluates. This architecture of the predictive model 700 enables the vehicle to prioritize responding to the most imminent fire risk.

In another embodiment, the predictive model 700 takes as inputs sensor data 728 and evaluates, for each pre-defined output fire scenario, whether the output fire scenario is likely to occur. For example, to evaluate whether there is a scenario of cabin fire, the predictive model 700 calculates, based on the input sensor data 728, a cabin fire score 712, representing high probability of cabin fire, and a no cabin fire score, representing low probability of cabin fire. In other words, in this embodiment, the set of fire risk scores 710 generated by the predictive model 700 contains exactly two elements, the cabin fire score 712 and the no cabin fire score. The threshold likelihood is the maximum likelihood score in the set of fire risk scores 710. If the cabin fire score 712 is greater than the no cabin fire score, a cabin fire is an output fire scenario. Similarly, the predictive model 700 can determine, based on the same input sensor data 728, whether an engine fire or a hood fire is an output fire scenario 616. In such an embodiment, the predictive model 700 should only determine the default scenario as the only output fire scenario if there is no or low fire risk. This architecture of the predictive model 700 is capable of determining multiple output fire scenarios 616 based on the same set of sensor data 728.

In an embodiment, the predictive model 700 takes the form of a rule-based decision tree. The predictive model 700 also generates fire risk data in the form of a set of fire risk scores 710. The threshold likelihood used to select the output fire scenario is either dynamic or pre-determined. In an embodiment, the threshold likelihood is the maximum likelihood score in the set of fire risk scores 710, which is dynamic as explained above. In an embodiment, the threshold likelihood is a pre-defined numerical value. Once the likelihood score for a fire scenario meets pre-defined numerical value, the fire scenario is classified as likely.

For example, in an embodiment, there is a threshold likelihood value of 0.7, a cabin fire score 712 of 0.6 and engine fire score 714 of 0.75 and a hood fire score 716 of 0.8, with higher values indicating higher likelihood of fire starting. In such an embodiment, both engine fire and hood fire are thus selected as the output fire scenarios. Furthermore, in such an embodiment, the cabin fire score 712, the engine fire score 714 the hood fire score 716 are calculated based on the mutual influence of a corresponding scenario on each other. For example, in an embodiment, a high engine fire score 714 would also increase the hood fire score 716. In such an embodiment, an increment of 0.1 in engine fire score 714 translates to an increment of 0.08 in the hood fire score 716. This design will help detecting latent fire risks more quickly.

In an embodiment, two threshold likelihoods are used for the rule-based decision tree predictive model 700, namely the fire prevention threshold and the fire mitigation threshold. In an embodiment, the fire prevention thresholds and fire mitigation thresholds are determined at least partially by an on-board processing circuit local to the vehicle, such as the processor 304 shown in FIG. 3. In an embodiment, the fire prevention thresholds and fire mitigation thresholds are determined at least partially by a remote processing circuit, such as part of the cloud 202 shown in FIG. 2. Following this exemplary embodiment, if the fire prevention threshold is set to 0.7 and the fire mitigation threshold is set to 0.8, an activation signal will be sent to the fire prevention controller to handle engine fire and hood fire, and another activation signal will be sent to the fire mitigation controller to handle hood fire. Details regarding the fire prevention controller and the fire mitigation controller can be found below in accordance with FIG. 8.

In an embodiment, the predictive model 700 takes the form of a neural network augmented by a decision tree. The threshold likelihoods used to determine the output fire scenario 616 are either dynamic or pre-determined, as explained above. This architecture is capable of generating multiple output fire scenarios 616 as well.

FIG. 8 shows a block diagram 800 of an implementation of the fire response control system 624. The fire response control system 624 comprises two parts, namely a fire prevention controller 810 and a fire mitigation controller 820. The fire prevention controller 810 includes a fire prevention initiator 812.The fire mitigation controller 820 includes a fire mitigation initiator 822.

The fire prevention initiator 812 takes an output fire scenario 616 as input. If the output fire scenario 616 is the default scenario or otherwise corresponds to the low fire risk signal 510, the fire prevention initiator 812 waits for the next output fire scenario 616. If the output fire scenario 616 indicates fire starting or corresponds to high fire risk signal 508, the fire prevention threshold is met. Then the fire prevention initiator 812 generates part of activation signals 626 to fire prevention effectors 830, which are part of vehicle fire control system 628, and initiates a timer signal 814. Upon initiation of the timer signal 814, a timer begins to tally a duration of time. In embodiments, the duration is transmitted via the timer signal 814.

The fire prevention effectors 830 generate control signals 632 to command vehicle components 634 to effect fire prevention measures. In an embodiment, when the output fire scenario 616 is identified as a hood fire, the fire prevention effectors 830 transmit a control signal to deactivate a vehicle component 634 (e.g., an engine) of the vehicle. In an embodiment, when the output fire scenario 616 is identified as cabin fire, the fire prevention effectors 830 alert, based on a current status of the vehicle, using at least one output interface as a vehicle component 634, such as a display or a speaker, passengers, bystanders or pedestrians in the vicinity of the vehicle. In an embodiment, when the output fire scenario 616 is identified as engine fire, the fire prevention effectors 830 alert transmit data representing an alert to a remote operator for assistance, using possibly an on-vehicle transmitter as a vehicle component 634.

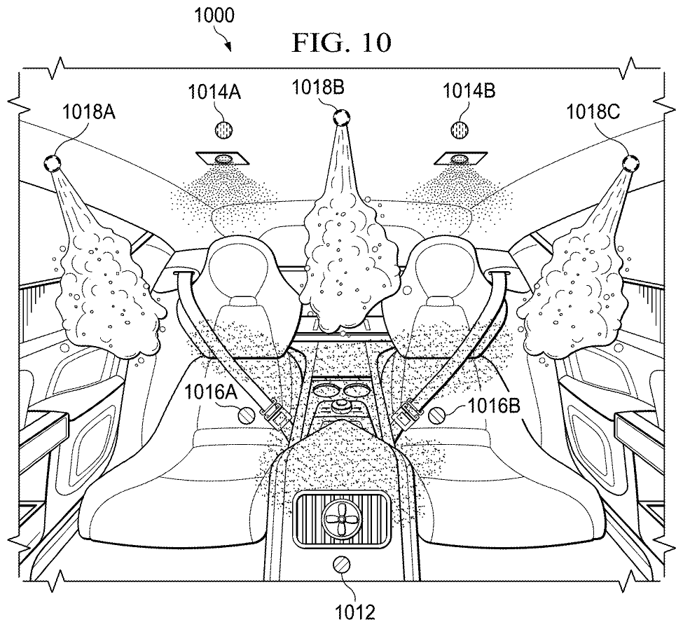

The fire mitigation initiator 822 activates if the output fire scenario 616 indicates fire starting or corresponds to high fire risk signal 508. The fire mitigation initiator 822 also takes as input the timer signal 814 generated by the fire prevention initiator 812. If the output fire scenario 616 indicates fire starting or corresponds to high fire risk signal 508, the timer signal 814 persists and corresponds to the persistence of fire risk signal 516 shown in FIG. 5. In an embodiment, the timer signal 814 is replaced with a step function applied on the output fire scenario 616 signal. If the timer signal 814 lasts longer than a threshold time, which is also known as the fire mitigation threshold, the fire is not successfully prevented and thus requires mitigation. Then the fire mitigation initiator 822 generates part of activation signals 626 to fire mitigation effectors 832 which are part of vehicle fire control system 628. An example set of fire mitigation effectors 832 is the fire mitigation systems 1000 shown below in FIG. 10.

The timer signal 814 resets when the output fire scenario 616 is the default scenario or otherwise corresponds to the low fire risk signal 510. When the timer signal 814 resets before meeting the fire mitigation threshold, the fire is considered to be successfully prevented and no fire mitigation measure is required. In an embodiment, a fire prevented signal 518 is generated by applying a falling edge trigger on the timer signal 814.

The fire mitigation effectors 832 generate control signals 632 to command vehicle components 634 to effect fire mitigation measures. An example implementation of fire mitigation measures is described in accordance with FIG. 10. The control signals 632 are generated when the fire persists, or when the persistence of fire risk signal 516 is generated, regardless of the specific fire scenarios. Hence, a persistent engine fire would warrant the same control signals 632 from the fire mitigation initiator 822 as a persistent cabin fire.

In an embodiment, the fire mitigation initiator 822 transmits a control signal to cause an in-vehicle system to disperse at least one material having extinguishing properties possibly stored in a compartment as a vehicle component 634, such as liquid carbon dioxide or sodium bicarbonate foam. In an embodiment, the fire mitigation initiator 822 transmits a control signal to cause at least one seat on the vehicle as a vehicle component 634 to cause a passenger to be safely released from the vehicle, such as via seat belt quick release mechanism, a door lock, and/or the like. In an embodiment, the fire mitigation initiator 822 transmits a control signal to disperse at least one coolant (e.g., liquid nitrogen) when safe to do so. In examples, the coolant is stored in a compartment as a vehicle component 634. In an embodiment, the fire mitigation initiator 822 transmits, using possibly an on-vehicle transmitter as a vehicle component 634, data representing an alert to authorities, such as calling the Federal Highway Administration or an emergency service such as police, medical, or fire services.

FIG. 9 shows an illustration 900 of an implementation of a sensor array 910 used in fire detection. The sensors include sensors 910A, 910B, 910C and 910D, collectively referred to as a sensor array 910. Particular sensors are described for exemplary purposes, and the present techniques are not limited to the use of particular sensors. In the example of FIG. 9, a fire 902 has produced some smoke 906. In an embodiment, the sensor array is in the interior of the vehicle. In an embodiment, the sensor array 910 includes various sensors, for example, audio sensors 910A and 910B (e.g., configured to generate audio data associated with sounds occurring inside and/or outside of the cabin of a vehicle). In embodiments, the audio sensor 910A and audio sensor 910B captures data that characterizes an audio environment 908 associated with the vehicle. In embodiments, the sensor array 910 includes chemical sensors (e.g., configured to generate chemical sensor data associated with concentration reading of at least one chemical substance). The chemical sensor may be, for example, a gas detection sensors or cabin smoke sensors 910D.

In an embodiment, a dual-purpose sensor 910C can detect sound, chemical, temperature and image data. In examples, the dual-purpose sensors 910C are configured to generate thermal sensor data associated with at least one temperature reading, and also configured to generate camera data associated with at least one image. Accordingly, in embodiments the dual-purpose sensor 910C is a dual purpose thermal sensor. In examples, the dual-purpose sensors 910C is a thermal camera. In an embodiment, other types of single-purpose or multi-purpose sensors are used to detect sound, chemical, temperature and image signals. In operation, the AV detects a heat signature using the sensor array 910. In embodiments, the heat signature is generated periodically. A heat signature prior to the start of the fire 902 is compared to a heat signature after the start of the fire 902. The heat signature is determined using data captured by a dual purpose thermal sensor. Additionally, in embodiments sensor data is cross checked between sensor modalities. For example, the data captured by a first sensor that indicates a likelihood of a fire is cross checked with data captured by a second sensor. In the example of FIG. 9, data from a dual purpose thermal sensor is cross checked with data captured by audio sensors 910A and 910B.

FIG. 10 shows an illustration of a fire mitigation system 1000. In examples, the fire mitigation system 1000 includes a fire mitigation controller 820, fire mitigation initiator 822, and fire mitigation effectors 832 (FIG. 8). In an embodiment, a cooling system portion of the fire mitigation system 1000 includes a ventilation system 1012, a sprinkler system with sprinkler heads 1014A and 1014B. The sprinkler system is configured to release, for example, liquid or gaseous coolants or fire extinguishing substances. In an embodiment, an automatic seat belt detacher system includes belts 1016A and 1016B that secure passengers within a respective seat. The automatic seat belt detacher system includes a safe seat ejection system to safely deliver the passenger out of the vehicle in response to a hazard within the vehicle, such as a fire. In examples, the belts 1016A and 1016B are released to safely deliver the passenger from the vehicle. In an embodiment, the foam expeller system includes expellers 1018A and 1018B. The foam expellers release multiple chemicals with combustion inhibiting effects in response to a fire being likely. The systems 1012, 1014, 1016 and 1018 are example vehicle components 634.

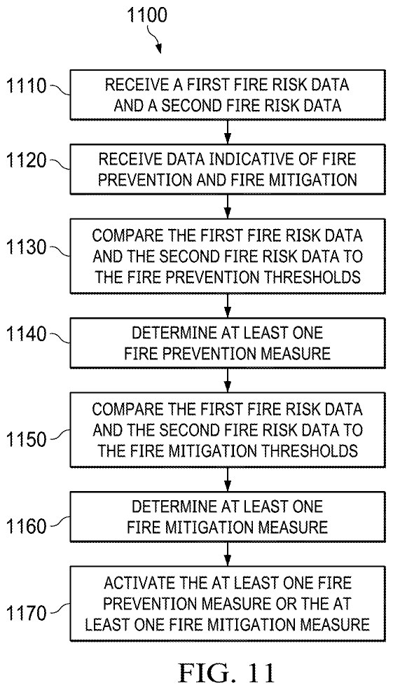

FIG. 11 is a flowchart representing a process 1100 for carrying out fire prevention measures and/or fire mitigation measures on a vehicle. In an embodiment, the vehicle is the AV 100 shown in FIG. 1, and the process 1100 is carried out by a processor 304 shown in FIG. 3.

At block 1110, a the first fire risk data indicative of a first imminent fire risk condition and a second fire risk data indicative of a second imminent fire risk condition are received. In an embodiment, the first fire risk data is a cabin fire score 712 shown in FIG. 7, and the first imminent fire risk condition is a cabin fire associated with the cabin fire score 712 shown in FIG. 7. In an embodiment, the second fire risk data is an engine fire score 714 shown in FIG. 7, and the second imminent fire risk condition is an engine fire associated with the engine fire score 714 shown in FIG. 7. In an embodiment, the first fire risk data is the cabin fire score 712, the second fire risk data is the no cabin fire score and the first and second imminent fire risk conditions are a cabin fire, as described in accordance with FIG. 7.

At block 1120, data indicative of fire prevention and fire mitigation is received, the data including fire prevention thresholds and fire mitigation thresholds. In an embodiment, the data indicative of fire prevention and fire mitigation include fire prevention and fire mitigation instructions, which are part of the instruction data 630 shown in FIG. 6. In an embodiment, a fire prevention threshold is the maximum likelihood score in the set of fire risk scores 710 shown in FIG. 7. In an embodiment, a fire mitigation threshold is a pre-determined threshold time associated with the timer signal 814 shown in FIG. 8. In an embodiment, the fire prevention thresholds and fire mitigation thresholds are determined at least partially by an on-board processing circuit local to the vehicle, such as the processor 304 shown in FIG. 3. In an embodiment, the fire prevention thresholds and fire mitigation thresholds are determined at least partially by a remote processing circuit, such as part of the cloud 202 shown in FIG. 2.

At block 1130, the first fire risk data and the second fire risk data are compared to the fire prevention thresholds. In an embodiment, the first fire risk data is the cabin fire score 712, the second fire risk data is the engine fire score 714 and the fire prevention threshold is the maximum likelihood score in the set of fire risk scores 710 as shown in FIG. 7.

At block 1140, at least one fire prevention measure applicable to the first imminent fire risk condition or the second imminent fire risk condition is determined. In an embodiment, the first imminent fire risk condition is a cabin fire and the fire prevention measure applicable to the first imminent fire risk condition is providing, using at least one output interface, an alert to passengers based on a current status of the vehicle, from the fire prevention effectors 830 described in accordance with FIG. 8. In an embodiment, the second imminent fire risk condition is an engine fire and the fire prevention measure applicable to the second imminent fire risk condition is transmitting a control signal to deactivate an engine of the vehicle, from the fire prevention effectors 830 described in accordance with FIG. 8.

At block 1150, the first fire risk data and the second fire risk data are compared to the fire mitigation thresholds. In an embodiment, the first fire risk data is the cabin fire score 712 shown in FIG. 7, the second fire risk data is the engine fire score 714 shown in FIG. 7 and the fire prevention threshold is the timer signal 814, as shown in FIG. 8, reflecting the duration of the output fire scenarios 616 associated with the first fire risk data and the second fire risk data.

At block 1160, at least one fire mitigation measure applicable to the first imminent fire risk condition or the second imminent fire risk condition are determined. In an embodiment, the first imminent fire risk condition is a cabin fire and the fire mitigation measure applicable to the first imminent fire risk condition is transmitting a control signal to cause at least one seat on the vehicle to cause a passenger to be safely released from the vehicle, from the fire mitigation effectors 832 described in accordance with FIG. 8. In an embodiment, the second imminent fire risk condition is an engine fire and the fire mitigation measure applicable to the second imminent fire risk condition is transmitting a control signal to disperse at least one material having extinguishing properties, such as liquid nitrogen, from the fire mitigation effectors 832 described in accordance with FIG. 8.

At block 1170, the at least one fire prevention measure or the at least one fire mitigation measure is activated. In an embodiment, the at least one fire prevention measure is performed via the fire prevention effectors 830 while the at least one fire mitigation measure via the fire mitigation effectors 832, as described in accordance with FIG. 8. In examples, activating the at least one fire prevention measure or the at least one fire mitigation measure includes executing one or more predetermined mitigation measures known to eliminate or reduce a most likely cause of fire.

According to some non-limiting embodiments or examples, provided is a vehicle, comprising: at least one computer-readable medium storing computer-executable instructions; and at least one processor communicatively coupled to the sensors and configured to execute the computer executable instructions, the execution carrying out operations including at least one of the following: receiving the first fire risk data and the second fire risk data from sensors, wherein the sensors are configured to detect conditions associated with imminent fire risk, the sensors including a first sensor configured to generate first fire risk data indicative of a first imminent fire risk condition and a second sensor configured to generate second fire risk data indicative of a second imminent fire risk condition; receiving data indicative of fire prevention and fire mitigation, the data including fire prevention thresholds and fire mitigation thresholds; comparing the first fire risk data and the second fire risk data to the fire prevention thresholds and, in response, determining at least one fire prevention measure applicable to the first imminent fire risk condition and the second imminent fire risk condition; comparing the first fire risk data and the second fire risk data to the fire mitigation thresholds, and, in response, determining at least one fire mitigation measure applicable to the first imminent fire risk condition and the second imminent fire risk condition; and activating the at least one fire prevention measure or the at least one fire mitigation measure.

According to some non-limiting embodiments or examples, provided is a method comprising: receiving, using at least one processor, first fire risk data and second fire risk data from sensors configured to detect conditions associated with imminent fire risk, the sensors including a first sensor configured to generate the first fire risk data, the first fire risk data indicative of a first imminent fire risk condition, and a second sensor configured to generate the second fire risk data, the second fire risk data indicative of a second imminent fire risk condition; receiving, using the at least one processor, data indicative of fire prevention and fire mitigation, the data including fire prevention thresholds and fire mitigation thresholds; comparing, using the at least one processor, the first fire risk data and the second fire risk data to the fire prevention thresholds and, in response, determining at least one fire prevention measure applicable to the first imminent fire risk condition and the second imminent fire risk condition; comparing, using the at least one processor, the first fire risk data and the second fire risk data to the fire mitigation thresholds, and, in response, determining at least one fire mitigation measure applicable to the first imminent fire risk condition and the second imminent fire risk condition; and activating, using the at least one processor, the at least one fire prevention measure or the at least one fire mitigation measure.

According to some non-limiting embodiments or examples, provided is a non-transitory computer-readable storage medium comprising at least one program for execution by at least one processor of a first device, the at least one program including instructions which, when executed by the at least one processor, cause the first device to perform operations comprising: receiving, using at least one processor, first fire risk data and second fire risk data from sensors configured to detect conditions associated with imminent fire risk, the sensors including a first sensor configured to generate the first fire risk data, the first fire risk data indicative of a first imminent fire risk condition, and a second sensor configured to generate the second fire risk data, the second fire risk data indicative of a second imminent fire risk condition; receiving, using the at least one processor, data indicative of fire prevention and fire mitigation, the data including fire prevention thresholds and fire mitigation thresholds; comparing, using the at least one processor, the first fire risk data and the second fire risk data to the fire prevention thresholds and, in response, determining at least one fire prevention measure applicable to the first imminent fire risk condition and the second imminent fire risk condition; comparing, using the at least one processor, the first fire risk data and the second fire risk data to the fire mitigation thresholds, and, in response, determining at least one fire mitigation measure applicable to the first imminent fire risk condition and the second imminent fire risk condition; and activating, using the at least one processor, the at least one fire prevention measure or the at least one fire mitigation measure.

Further non-limiting aspects or embodiments are set forth in the following numbered clauses:

Clause 1: A vehicle, comprising: at least one computer-readable medium storing computer-executable instructions; and at least one processor communicatively coupled to the sensors and configured to execute the computer executable instructions, the execution carrying out operations including at least one of the following: receiving the first fire risk data and the second fire risk data from sensors, wherein the sensors are configured to detect conditions associated with imminent fire risk, the sensors including a first sensor configured to generate first fire risk data indicative of a first imminent fire risk condition and a second sensor configured to generate second fire risk data indicative of a second imminent fire risk condition;

receiving data indicative of fire prevention and fire mitigation, the data including fire prevention thresholds and fire mitigation thresholds; comparing the first fire risk data and the second fire risk data to the fire prevention thresholds and, in response, determining at least one fire prevention measure applicable to the first imminent fire risk condition and the second imminent fire risk condition; comparing the first fire risk data and the second fire risk data to the fire mitigation thresholds, and, in response, determining at least one fire mitigation measure applicable to the first imminent fire risk condition and the second imminent fire risk condition; and activating the at least one fire prevention measure or the at least one fire mitigation measure.

Clause 2: The vehicle of clause 1, wherein the fire prevention thresholds and fire mitigation thresholds are determined at least partially by an on-board processing circuit local to the vehicle.

Clause 3: The vehicle of clause 1 or 2, wherein the fire prevention thresholds and fire mitigation thresholds are determined at least partially by a remote processing circuit.

Clause 4: The vehicle of any of clauses 1-3, wherein the fire prevention thresholds and fire mitigation thresholds are determined at least partially from historical data indicative of fire risk conditions of other vehicles.

Clause 5: The vehicle of any of clauses 1-4, wherein the fire prevention measures comprise at least one of: transmitting a control signal to deactivate an engine of the vehicle; providing, using at least one output interface, an alert to passengers based on a current status of the vehicle; providing, using at least one output interface, an alert to bystanders or pedestrians in a vicinity of the vehicle based on a current status of the vehicle; or transmitting data representing an alert to a remote operator for assistance.

Clause 6: The vehicle of any of clauses 1-5, wherein the fire mitigation measures comprise at least one of: transmitting a control signal to disperse at least one material having extinguishing properties; transmitting a control signal to cause at least one seat on the vehicle to cause a passenger to be safely released from the vehicle; transmitting a control signal to disperse at least one coolant; or transmitting data representing an alert to authorities.

Clause 7: A method comprising: receiving, using at least one processor, first fire risk data and second fire risk data from sensors configured to detect conditions associated with imminent fire risk, the sensors including a first sensor configured to generate the first fire risk data, the first fire risk data indicative of a first imminent fire risk condition, and a second sensor configured to generate the second fire risk data, the second fire risk data indicative of a second imminent fire risk condition; receiving, using the at least one processor, data indicative of fire prevention and fire mitigation, the data including fire prevention thresholds and fire mitigation thresholds; comparing, using the at least one processor, the first fire risk data and the second fire risk data to the fire prevention thresholds and, in response, determining at least one fire prevention measure applicable to the first imminent fire risk condition and the second imminent fire risk condition; comparing, using the at least one processor, the first fire risk data and the second fire risk data to the fire mitigation thresholds, and, in response, determining at least one fire mitigation measure applicable to the first imminent fire risk condition and the second imminent fire risk condition; and activating, using the at least one processor, the at least one fire prevention measure or the at least one fire mitigation measure.

Clause 8: The method of clause 7, wherein the fire prevention thresholds and fire mitigation thresholds are determined at least partially by an on-board processing circuit local to a vehicle.

Clause 9: The method of clause 7 or 8, wherein the fire prevention thresholds and fire mitigation thresholds are determined at least partially by a remote processing circuit.

Clause 10: The method of any of clauses 7-9, wherein the fire prevention thresholds and fire mitigation thresholds are determined at least partially from historical data indicative of fire risk conditions of other vehicles.

Clause 11: The method of any of clauses 7-10, wherein the fire prevention measures comprise at least one of: transmitting a control signal to deactivate an engine of the vehicle; providing, using at least one output interface, an alert to passengers based on a current status of the vehicle; providing, using at least one output interface, an alert to bystanders or pedestrians in a vicinity of the vehicle based on a current status of the vehicle; or transmitting data representing an alert to a remote operator for assistance.

Clause 12: The method of any of clauses 7-11, wherein the fire mitigation measures comprise at least one of: transmitting a control signal to disperse at least one material having extinguishing properties; transmitting a control signal to cause at least one seat on the vehicle to cause a passenger to be safely released from the vehicle; transmitting a control signal to disperse at least one coolant; or transmitting data representing an alert to authorities.

Clause 13: A non-transitory computer-readable storage medium comprising at least one program for execution by at least one processor of a first device, the at least one program including instructions which, when executed by the at least one processor, cause the first device to perform operations comprising: receiving, using at least one processor, first fire risk data and second fire risk data from sensors configured to detect conditions associated with imminent fire risk, the sensors including a first sensor configured to generate the first fire risk data, the first fire risk data indicative of a first imminent fire risk condition, and a second sensor configured to generate the second fire risk data, the second fire risk data indicative of a second imminent fire risk condition; receiving, using the at least one processor, data indicative of fire prevention and fire mitigation, the data including fire prevention thresholds and fire mitigation thresholds; comparing, using the at least one processor, the first fire risk data and the second fire risk data to the fire prevention thresholds and, in response, determining at least one fire prevention measure applicable to the first imminent fire risk condition and the second imminent fire risk condition; comparing, using the at least one processor, the first fire risk data and the second fire risk data to the fire mitigation thresholds, and, in response, determining at least one fire mitigation measure applicable to the first imminent fire risk condition and the second imminent fire risk condition; and activating, using the at least one processor, the at least one fire prevention measure or the at least one fire mitigation measure.

Clause 14: The non-transitory computer-readable storage medium of clause 13, wherein the fire prevention thresholds and fire mitigation thresholds are determined at least partially by an on-board processing circuit local to a vehicle.

Clause 15: The non-transitory computer-readable storage medium of clause 13 or 14, wherein the fire prevention thresholds and fire mitigation thresholds are determined at least partially by a remote processing circuit.

Clause 16: The non-transitory computer-readable storage medium of clauses 13-15, wherein the fire prevention thresholds and fire mitigation thresholds are determined at least partially from historical data indicative of fire risk conditions of other vehicles.

Clause 17: The non-transitory computer-readable storage medium of clauses 13-16, wherein the fire prevention measures comprise at least one of: transmitting a control signal to deactivate an engine of the vehicle; providing, using at least one output interface, an alert to passengers based on a current status of the vehicle; providing, using at least one output interface, an alert to bystanders or pedestrians in a vicinity of the vehicle based on a current status of the vehicle; or transmitting data representing an alert to a remote operator for assistance.

Clause 18: The non-transitory computer-readable storage medium of clauses 13-17, wherein the fire mitigation measures comprise at least one of: transmitting a control signal to disperse at least one material having extinguishing properties; transmitting a control signal to cause at least one seat on the vehicle to cause a passenger to be safely released from the vehicle; transmitting a control signal to disperse at least one coolant; or transmitting data representing an alert to authorities.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A vehicle, comprising:
at least one computer-readable medium storing computer-executable instructions; and
at least one processor configured to execute the computer executable instructions, the execution carrying out operations including at least one of the following:
receiving first fire risk data and second fire risk data from sensors, wherein the sensors are configured to detect conditions associated with imminent fire risk, the sensors including a first sensor configured to generate first fire risk data indicative of a first imminent fire risk condition and a second sensor configured to generate second fire risk data indicative of a second imminent fire risk condition;
receiving data indicative of fire prevention and fire mitigation, the data including fire prevention thresholds and fire mitigation thresholds;
comparing the first fire risk data and the second fire risk data to the fire prevention thresholds and, in response, determining at least one fire prevention measure applicable to the first imminent fire risk condition and the second imminent fire risk condition;
comparing the first fire risk data and the second fire risk data to the fire mitigation thresholds, and, in response, determining at least one fire mitigation measure applicable to the first imminent fire risk condition and the second imminent fire risk condition; and
activating the at least one fire prevention measure or the at least one fire mitigation measure.

2. The vehicle of claim 1, wherein the fire prevention thresholds and fire mitigation thresholds are determined at least partially by an on-board processing circuit local to the vehicle.

3. The vehicle of claim 1, wherein the fire prevention thresholds and fire mitigation thresholds are determined at least partially by a remote processing circuit.

4. The vehicle of claim 1, wherein the fire prevention thresholds and fire mitigation thresholds are determined at least partially from historical data indicative of fire risk conditions of other vehicles.

5. The vehicle of claim 1, wherein the at least one fire prevention measure comprises:
transmitting a control signal to deactivate an engine of the vehicle;
providing, using at least one output interface, an alert to passengers based on a current status of the vehicle;
providing, using at least one output interface, an alert to bystanders or pedestrians in a vicinity of the vehicle based on a current status of the vehicle; or
transmitting data representing an alert to a remote operator for assistance.

6. The vehicle of claim 1, wherein the at least one fire mitigation measure comprises:
transmitting a control signal to disperse at least one material having extinguishing properties;
transmitting a control signal to cause at least one seat on the vehicle to cause a passenger to be safely released from the vehicle;
transmitting a control signal to disperse at least one coolant; or
transmitting data representing an alert to authorities.

7. A method comprising:
receiving, using at least one processor, first fire risk data and second fire risk data from sensors configured to detect conditions associated with imminent fire risk, the sensors including a first sensor configured to generate the first fire risk data, the first fire risk data indicative of a first imminent fire risk condition, and a second sensor configured to generate the second fire risk data, the second fire risk data indicative of a second imminent fire risk condition;
receiving, using the at least one processor, data indicative of fire prevention and fire mitigation, the data including fire prevention thresholds and fire mitigation thresholds;
comparing, using the at least one processor, the first fire risk data and the second fire risk data to the fire prevention thresholds and, in response, determining at least one fire prevention measure applicable to the first imminent fire risk condition and the second imminent fire risk condition;
comparing, using the at least one processor, the first fire risk data and the second fire risk data to the fire mitigation thresholds, and, in response, determining at least one fire mitigation measure applicable to the first imminent fire risk condition and the second imminent fire risk condition; and
activating, using the at least one processor, the at least one fire prevention measure or the at least one fire mitigation measure.

8. The method of claim 7, wherein the fire prevention thresholds and fire mitigation thresholds are determined at least partially by an on-board processing circuit local to a vehicle.

9. The method of claim 7, wherein the fire prevention thresholds and fire mitigation thresholds are determined at least partially by a remote processing circuit.

10. The method of claim 7, wherein the fire prevention thresholds and fire mitigation thresholds are determined at least partially from historical data indicative of fire risk conditions of other vehicles.

11. The method of claim 7, wherein the at least one fire prevention measure comprises:
transmitting a control signal to deactivate an engine of a vehicle;
providing, using at least one output interface, an alert to passengers based on a current status of the vehicle;
providing, using at least one output interface, an alert to bystanders or pedestrians in a vicinity of the vehicle based on a current status of the vehicle; or
transmitting data representing an alert to a remote operator for assistance.

12. The method of claim 7, wherein the at least one fire mitigation measure comprises:
transmitting a control signal to disperse at least one material having extinguishing properties;
transmitting a control signal to cause at least one seat of a vehicle to cause a passenger to be safely released from a vehicle;
transmitting a control signal to disperse at least one coolant; or
transmitting data representing an alert to authorities.

13. A non-transitory computer-readable storage medium comprising at least one program for execution by at least one processor of a first device, the at least one program including instructions which, when executed by the at least one processor, cause the first device to perform operations comprising:
receiving, using at least one processor, first fire risk data and second fire risk data from sensors configured to detect conditions associated with imminent fire risk, the sensors including a first sensor configured to generate the first fire risk data, the first fire risk data indicative of a first imminent fire risk condition, and a second sensor configured to generate the second fire risk data, the second fire risk data indicative of a second imminent fire risk condition;
receiving, using the at least one processor, data indicative of fire prevention and fire mitigation, the data including fire prevention thresholds and fire mitigation thresholds;
comparing, using the at least one processor, the first fire risk data and the second fire risk data to the fire prevention thresholds and, in response, determining at least one fire prevention measure applicable to the first imminent fire risk condition and the second imminent fire risk condition;
comparing, using the at least one processor, the first fire risk data and the second fire risk data to the fire mitigation thresholds, and, in response, determining at least one fire mitigation measure applicable to the first imminent fire risk condition and the second imminent fire risk condition; and
activating, using the at least one processor, the at least one fire prevention measure or the at least one fire mitigation measure.

14. The non-transitory computer-readable storage medium of claim 13, wherein the fire prevention thresholds and fire mitigation thresholds are determined at least partially by an on-board processing circuit local to a vehicle.

15. The non-transitory computer-readable storage medium of claim 13, wherein the fire prevention thresholds and fire mitigation thresholds are determined at least partially by a remote processing circuit.

16. The non-transitory computer-readable storage medium of claim 13, wherein the fire prevention thresholds and fire mitigation thresholds are determined at least partially from historical data indicative of fire risk conditions of other vehicles.

17. The non-transitory computer-readable storage medium of claim 13, wherein the at least one fire prevention measure comprises:
transmitting a control signal to deactivate an engine of a vehicle;
providing, using at least one output interface, an alert to passengers based on a current status of the vehicle;
providing, using at least one output interface, an alert to bystanders or pedestrians in a vicinity of the vehicle based on a current status of the vehicle; or
transmitting data representing an alert to a remote operator for assistance.

18. The non-transitory computer-readable storage medium of claim 13, wherein the at least one fire mitigation measure comprises:
transmitting a control signal to disperse at least one material having extinguishing properties;
transmitting a control signal to cause at least one seat of a vehicle to cause a passenger to be safely released from the vehicle;
transmitting a control signal to disperse at least one coolant; or
transmitting data representing an alert to authorities.
